(19) United States
(12) Patent Application Publication
(10) Pub. No.: US 2008/0236848 A1
(43) Pub. Date: Oct. 2, 2008

(54) Turf Cutter/De-Compactor/Trencher

(76) Inventor: William Lyle Warke, County Antrim (GB)

Correspondence Address: Robert C. Faber;OSTROLENK, FABER, GERB & SOFFEN, 1180 Avenue of the Americas, New York, NY, 10036-8402, US

(21) Appl. No.: 10/586,709

(22) PCT Filed: Jan. 20, 2005
(86) PCT No.: PCT/GB2005/000187

§ 371 Date: Jul. 20, 2006

(30) Foreign Application Priority Data
Jan. 20, 2004 (GB) 0401209.2

(51) Int. Cl. A01B 45/04

(52) U.S. Cl. 172/19

(57) ABSTRACT

An apparatus for cutting turf, for soil de-compacting and for soil drainage and irrigation. The apparatus has a chassis with a ground engaging means, an adjustable working arm having a chassis-engaging end movably mounted on the chassis and a tool-engaging end having means for receiving a tool. The apparatus also has means for oscillating the tool-engaging end of the adjustable working arm. The oscillating means comprises a drive means mounted on the chassis and a connecting means mounted intermediate the drive means and the adjustable working arm.

The present invention relates to turf cutters/de-compactors/trenchers and in particular to versatile precision turf cutters/de-compactors/trenchers.

Turf cutters have been used by Green-keepers and grounds-staff in the sports-turf sector of the industry for many years, mostly to remove old tired turf for replacement and for stripping healthy turf for relaying. The turf cutter is also quite often used to remove a narrow strip of turf for other purposes such as drainage, which can be re-laid on completion. Landscapers and contractors also find the Turf-cutter machine very useful for removing grass surfaces in preparation for shrub beds and pathways etc. or to be re-laid after construction work has been carried out. Healthy turf which has been cut for laying new grass areas or to replace worn turf obviously needs to be cleanly cut with no ragged edges but it is also vital that it be of a constant thickness to maintain a level finished surface. This is especially true in golf greens, bowling greens, cricket and fine lawns. These types of surfaces are often referred to as ‘fine turf.’ To enhance recovery of the source area the trend is to cut ever finer or thinner slices of turf. Additionally and certainly in the case of golf courses the areas selected for stripping may be undulating which compounds the problem of thickness consistency. When stripping large areas it is customary due to efficiency to cut all the turf first, then roll and remove it. A clear and unrestricted vision of the blade and the previous cut line is imperative in order to avoid overlapping i.e. cutting a portion out of the previous piece. Inability to accurately control this results in an uncut portion being left between. This in turn has to be removed in the interests of maintaining an even surface.

Pedestrian and tractor mounted types of turf-cutters are available. The tractor mounted machines are normally used by specialist contractors for the purpose of stripping larger areas or by turf farms for harvesting. Pedestrian operated machines are more suitable for the purpose described above but they fall short of the precision of cut achieved by the more sophisticated and hugely more expensive turf harvesters. The pedestrian machine should be capable of using a narrow blade for trenching or maximum depth requirements as well as a wide blade for large area stripping and relaying work. Changing blades should be simple for the operator. Precision of cut should remain

consistent and the operator's sight line for blade alignment in all widths of cuts should not be impeded.

Turf cutters have an oscillating blade which can be adjusted to the required depth and pulled or pushed through the turf by a ground engaging drum or wheels. The oscillating action enables the turf cutter machine to propel the blade through the ground with the minimum of traction or forward propulsion. Other operations could be performed using this principal, such as drainage, irrigation, de-compaction and trenching but the chassis and drive mechanism on traditional turf cutters do not lend themselves to accommodate the various blades or blade arrangements.

Accordingly, the present invention provides an apparatus for cutting turf, for soil de-compacting and for soil drainage and irrigation, the apparatus comprising a chassis have ground engaging means, an adjustable working arm having a chassis-engaging end movably mounted on the chassis and a tool-engaging end having means for receiving a tool, means for oscillating the tool-engaging end of the adjustable working arm wherein the oscillating means comprises a drive means mounted on the chassis and a connecting means mounted intermediate the drive means and the adjustable working arm.

Preferably, the connecting means is a single connecting rod.

Ideally, the drive means is a camshaft.

Preferably, the connecting rod is movably mounted on the adjustable working arm intermediate its two ends.

Ideally, the chassis-engaging end of the adjustable working arm is pivotally mounted on a housing which is movably mounted on the chassis.

Preferably, the housing is a depth-set housing which is movable along a substantially vertical axis for adjusting the depth of a tool relative to the surface of the ground.

Ideally, the ground engaging means comprises at least one axle carrying wheel means thereon, the apparatus being pivotable about the axle to allow the tool to be raised clear of the ground when out of use.

Preferably, the ground engaging means comprises a pair of axles, an aft axle adjacent the tool engaging end of the adjustable working arm and a forward axle and at least one axle carrying wheel means thereon. Ideally, both axles have wheel means thereon.

Ideally, the apparatus is pivotable about the forward axle to allow the tool to be raised clear of the ground when out of use.

Preferably, each axle has a wheel disposed on each end. The chassis, the adjustable working arm and the oscillating means are disposed intermediate the wheels of each axle.

Ideally, a turf cutting knife comprising a turf undercutting blade orientated substantially horizontally in use is mounted on the tool receiving means of the adjustable working arm and the turf undercutting blade is disposed substantially vertically below an axis of rotation of the aft axle.

Preferably, the turf undercutting blade is reinforced.

Ideally, the turf cutting knife comprises a turf undercutting blade and a turf side-cutting blade extending upward and rearward from each lateral edge of the turf undercutting blade, the side cutting blades having mounting means on their free ends for mounting the turf cutting knife onto the tool receiving means of the adjustable working arm.

Ideally, the tool receiving means comprises a crossbar mounted on the tool-engaging end of the adjustable working arm.

Preferably, the longitudinal axis of the crossbar is substantially parallel to the axis of rotation of the ground engaging means.

Ideally, the longitudinal axis of the crossbar is substantially perpendicular to the plane of oscillation of the adjustable working arm.

Preferably, the mounting means of the turf cutting knife comprise brackets extending from the side cutting blades and the brackets have means for releasably fastening the turf cutting knife to the crossbar.

Ideally, a range of turf cutting knives are provided with brackets of different lengths to accommodate blades and/or wheels of different widths.

Ideally, the side cutting blades have a main plane substantially parallel to the direction of travel of the turf cutting apparatus.

Preferably, the side cutting blades are disposed laterally along the outside of the ground engaging means. Advantageously, this allows an operator to visually align the last cut edge of turf with the side cutting blade of the turf cutting knife adjacent to the last cut edge.

In the case of mole draining and de-compaction when maximum depth is crucial, a single vertical blade is preferably centrally mounted on the crossbar.

Ideally, a guillotine is mounted on the aft portion of the chassis of the turf cutting apparatus and is operable between an out of use position where a cutting head of the guillotine is clear of the ground and an in use position where the cutting head slices vertically down into a strip of cut turf to produces strips of turf of a predetermined length.

Preferably, the guillotine is operated between its two positions by guillotine drive means taken off the main turf cutting apparatus drive means.

Ideally, the guillotine has a measuring means in operable engagement with a clutch means such that when a predetermined distance has been measured by the measuring means, the clutch means couples the guillotine cutting head to the guillotine drive means to operate the guillotine between the out of use position and the in use position and back to the out of use position effecting a chopping action by the guillotine cutting head.

Ideally, the measuring means is a wheel having wheel diameter adjustment means.

Preferably, a trench generating means is mounted on the tool engaging end of the adjustable working arm.

Ideally, the trench generating means comprises a wedge attachment having a leading edge blade and a trailing edge having means for receiving material dispensed from above.

Preferably, the means for receiving material comprises a pair of mutually opposing spaced apart wedge plates expanding in a v shape from the leading edge blade and terminating in a pair of parallel plates substantially planarly parallel with the leading edge blade.

Preferably, pipe dispensing means are mounted on the chassis of the apparatus.

Ideally, the pipe dispensing means and the trench generating means are mounted on the apparatus together for dispensing pipe into the material receiving means of the trench generating means for drainage and/or irrigation.

Ideally, the pipe dispensing means is a reel rotatably mounted on the chassis.

Preferably, guide means is mounted on the chassis of the apparatus for guiding the pipe from the reel into the trench via the material receiving means.

Ideally, a material hopper is mounted on the chassis and a material delivery means is connected intermediate the hopper and the material receiving means of the trench generating means.

Ideally, soil compacting means are mounted on the adjustable working arm to follow above the trench generating means for flattening any uneven ground surface.

Preferably, the soil compacting means is a roller.

The invention will now be described, by way of example only, with reference to the accompanying drawings. In the drawings:—

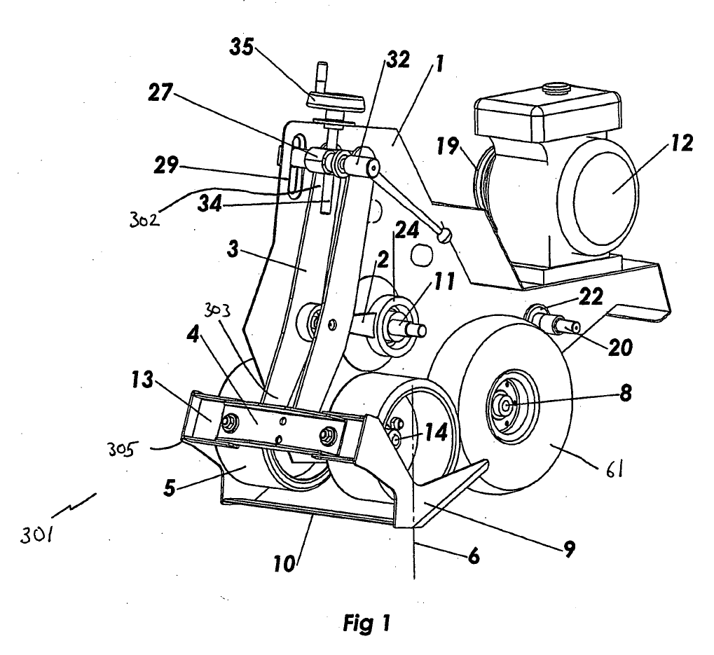

FIG. 1 is a perspective view of a turf cutting apparatus with the chassis side cut away,

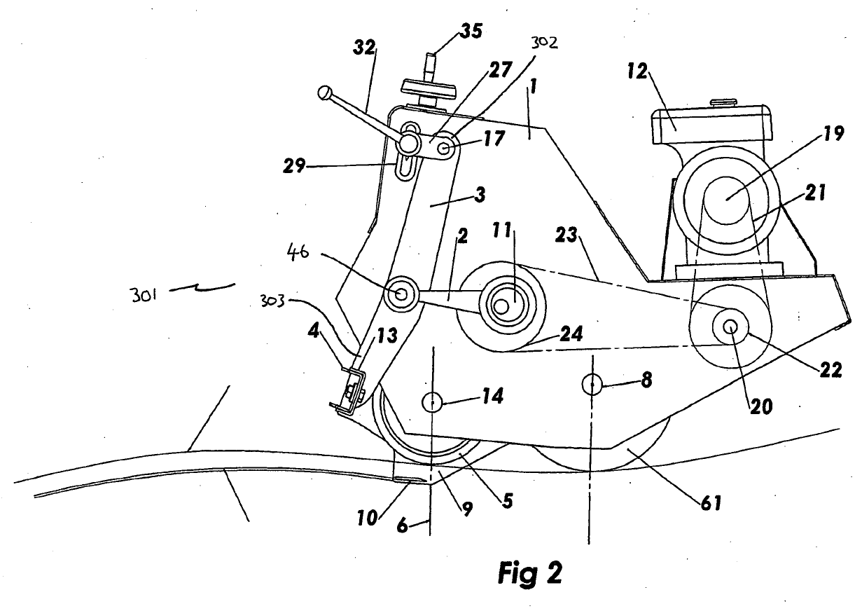

FIG. 2 is a side elevational view of a turf cutting apparatus illustrating precision of cut;

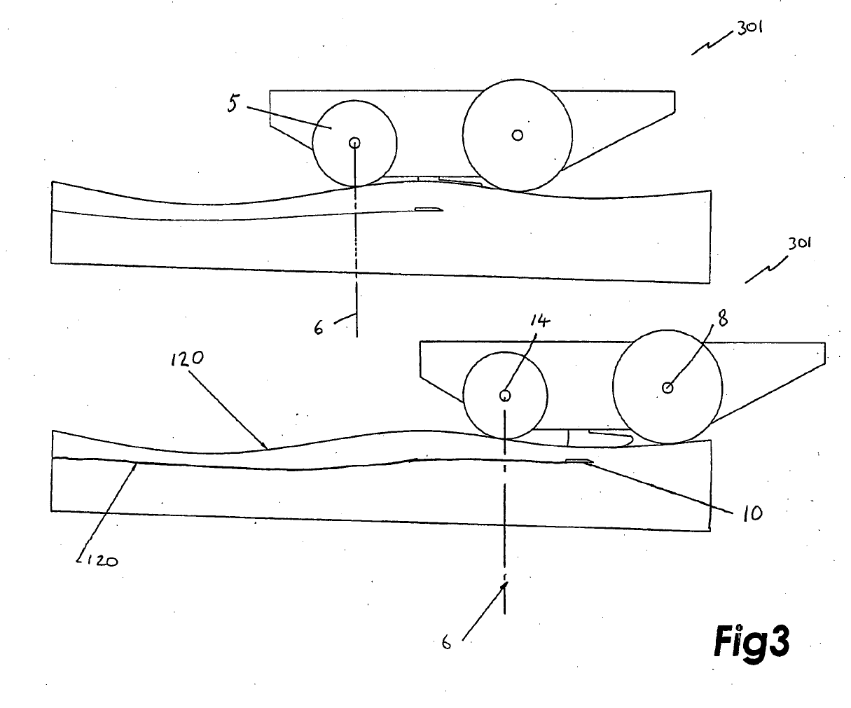

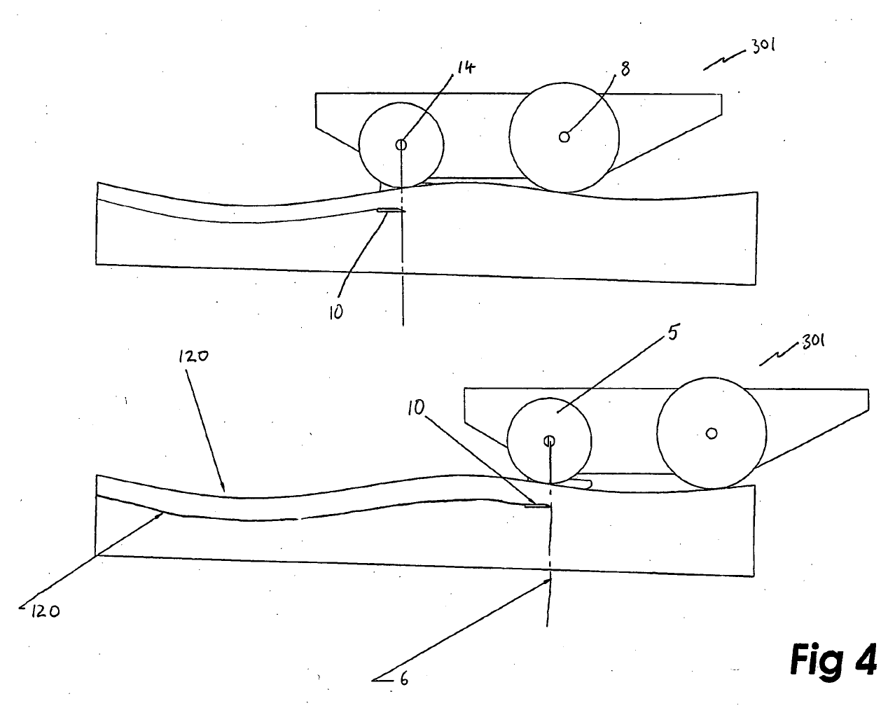

FIGS. 3, 4 & 5 are schematic drawings of alternative blade positions of the turf cutter blade;

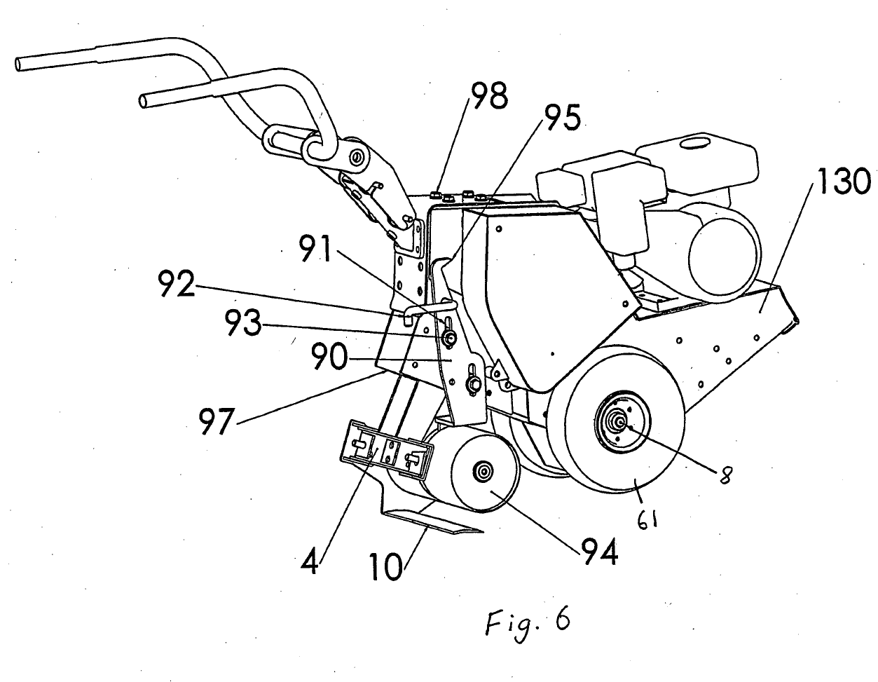

FIG. 6 is a perspective view of a second embodiment of turf cutting apparatus;

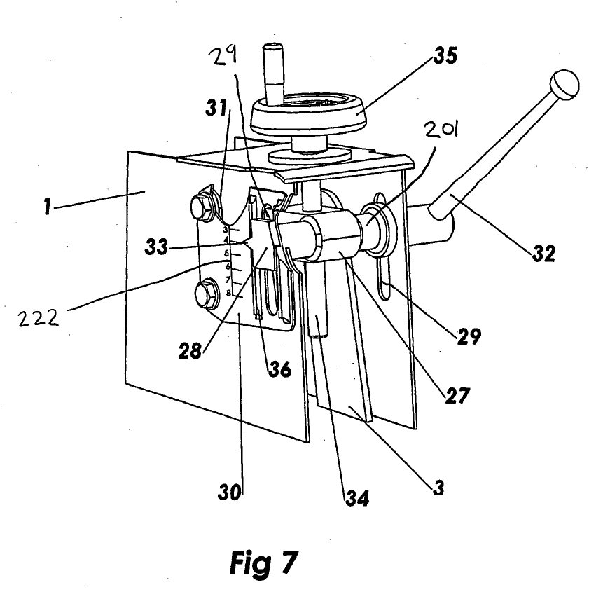

FIG. 7 is a perspective view of a depth setting mechanism;

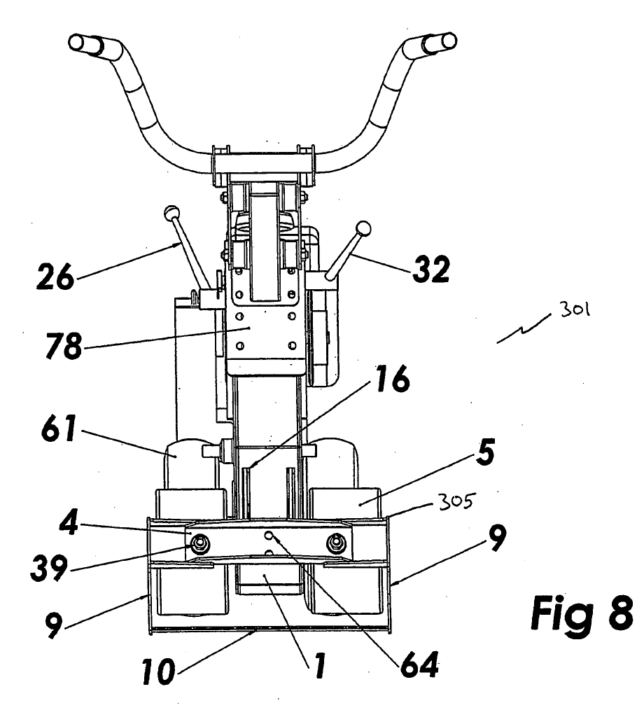

FIG. 8 is a rear view of the turf cutting apparatus of FIG. 1;

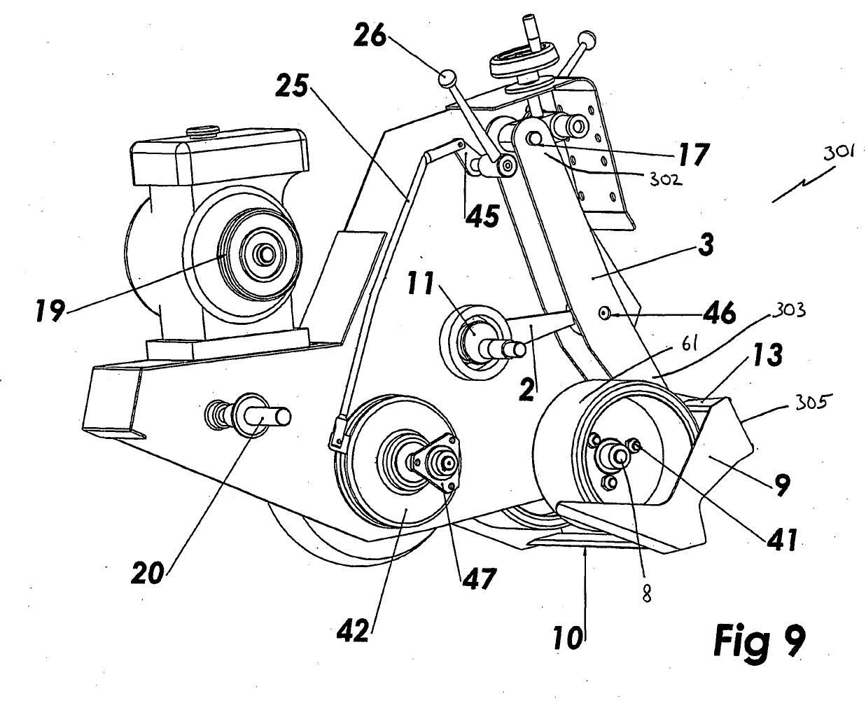

FIG. 9 is a partial cutaway perspective view of the turf cutting apparatus of FIG. 1 and FIG. 8;

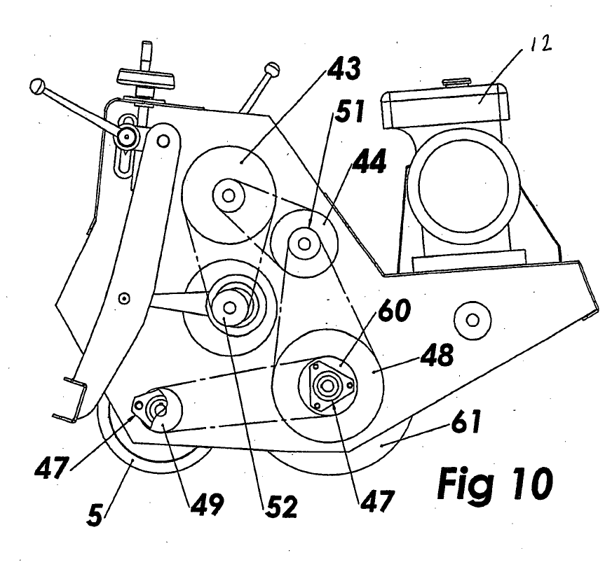

FIG. 10 is a partial side elevational view of the turf cutting apparatus of FIG. 1, FIG. 8 and FIG. 9;

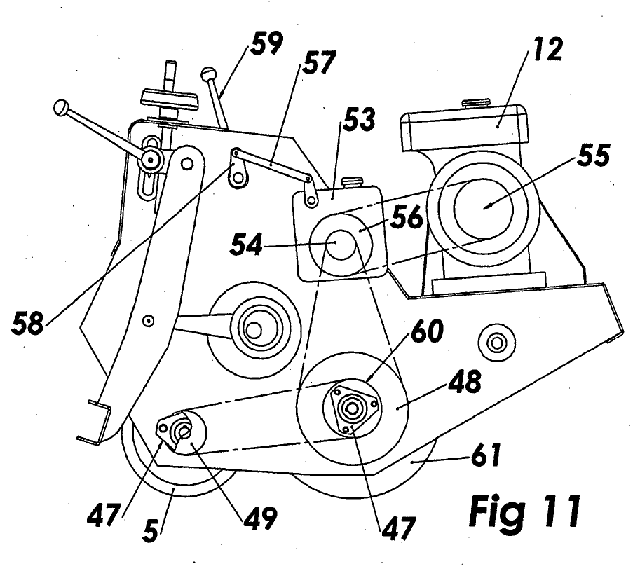

FIG. 11 is a partial side elevational view of the turf cutting apparatus of FIG. 1 and FIGS. 8 to 10;

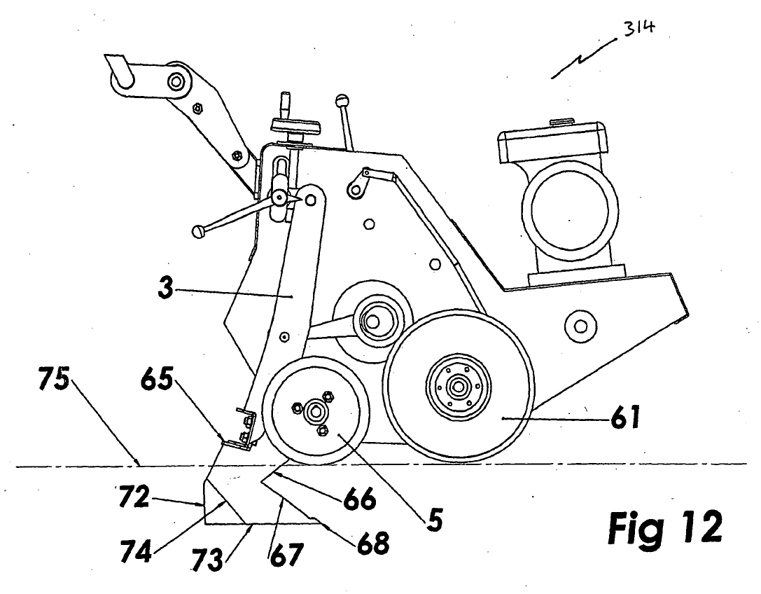

FIG. 12 is a partial side elevational view of a sub plough de-compactor apparatus;

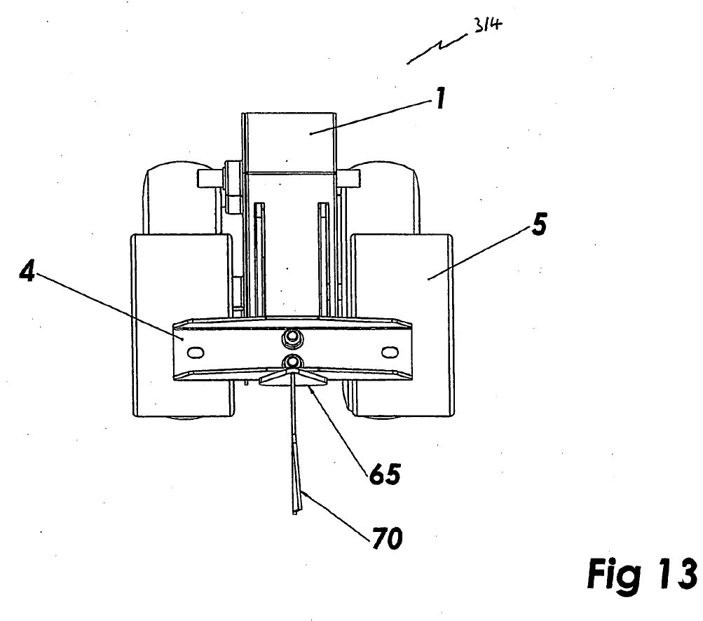

FIG. 13 is a rear view of the sub plough de-compactor apparatus of FIG. 12;

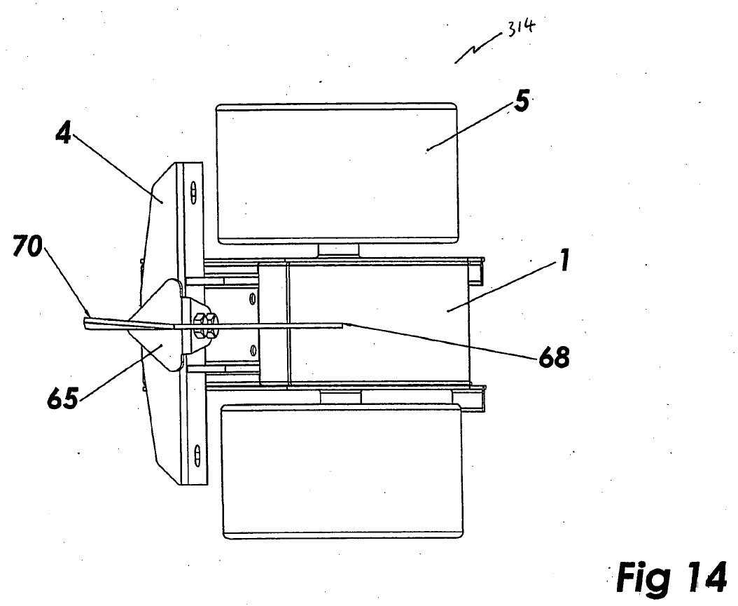

FIG. 14 is an underside plan view of the sub-plough de-compactor apparatus of FIGS. 12 and 13;

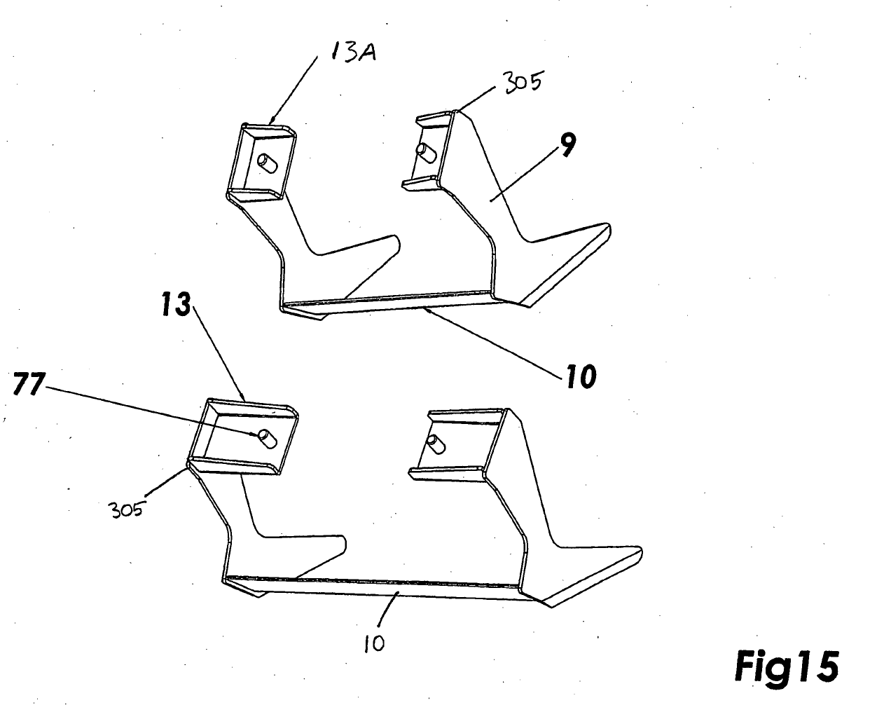

FIG. 15 is a perspective view showing a pair of interchangeable turf cutter knives;

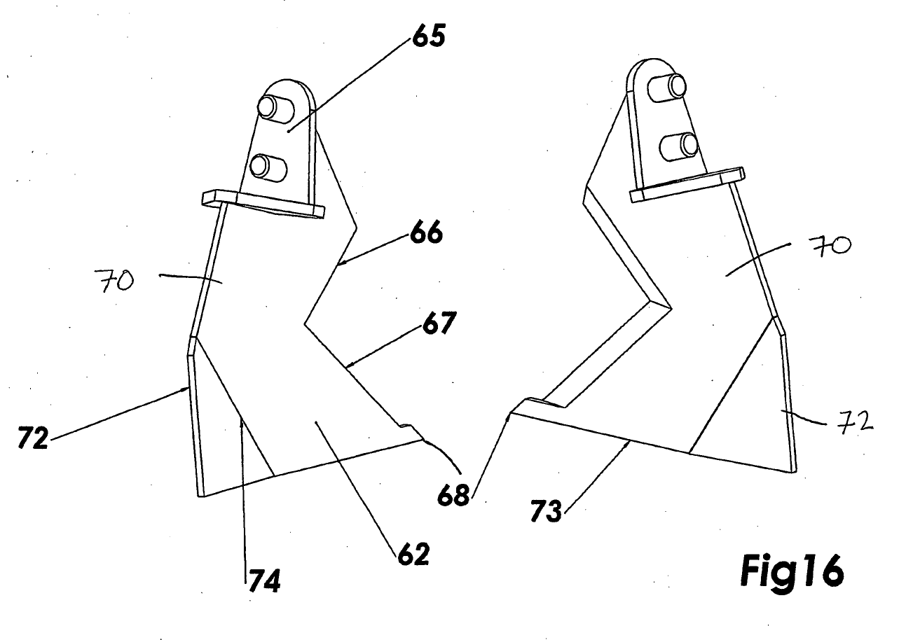

FIG. 16 is two perspective views of a sub plough de-compactor blade;

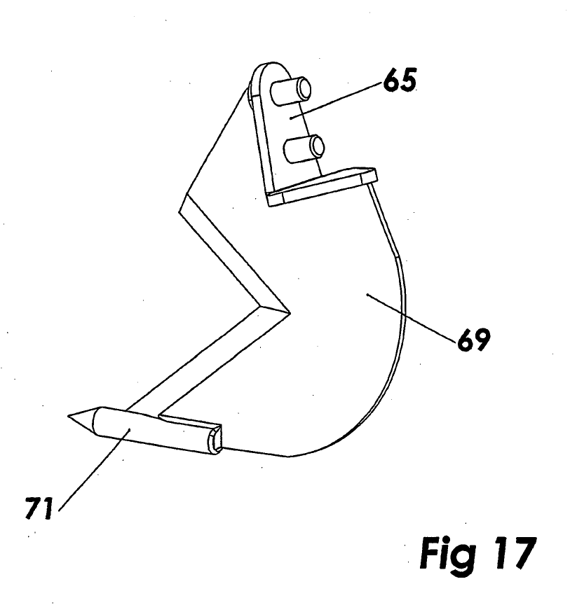

FIG. 17 is a perspective view of a mole drain blade;

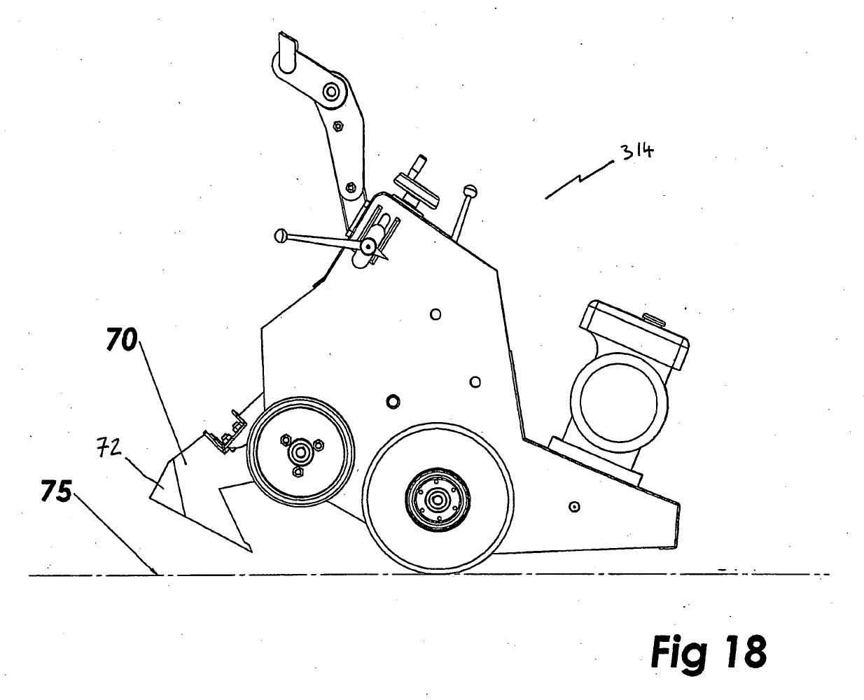

FIG. 18 is a partial side elevational view of the sub-plough de-compactor of FIGS. 12 to 14;

FIG. 19 is a perspective view of the turf cutting apparatus of FIG. 1 and FIGS. 8 to 11;

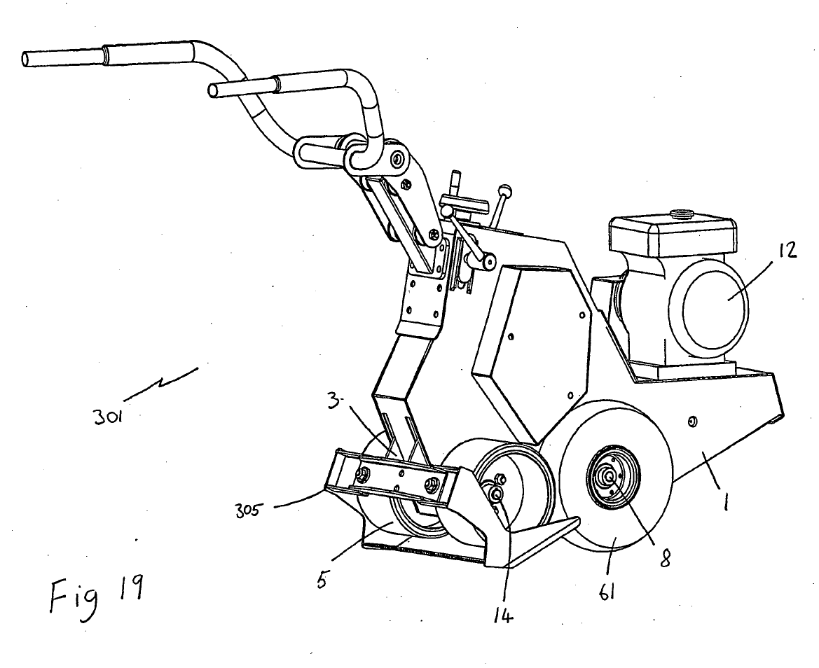

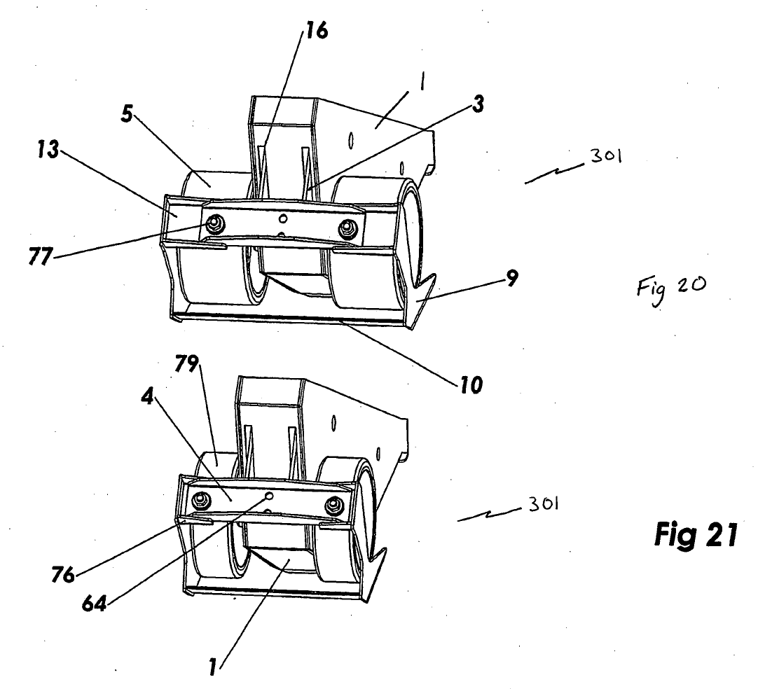

FIG. 20 is a partial perspective view of a turf cutting apparatus having a wide blade and wide blade wheels;

FIG. 21 is a partial perspective view of the turf cutting apparatus of FIG. 20 having a narrow blade and a narrow pair of blade wheels;

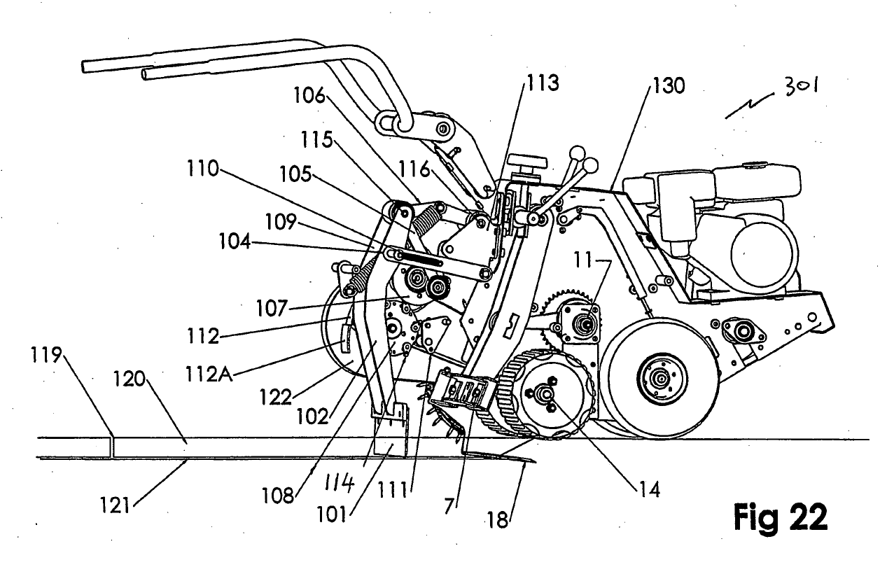

FIG. 22 is a perspective view of a turf cutting apparatus with a guillotine attachment;

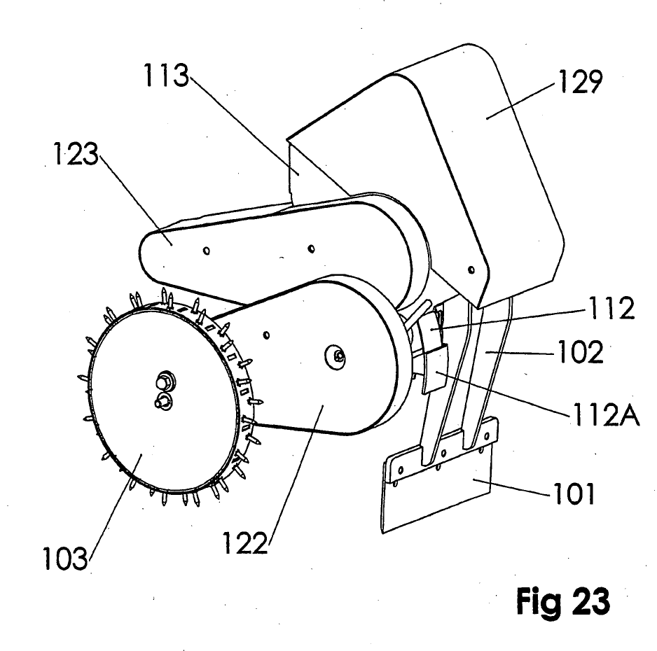

FIG. 23 is a perspective detail view of the guillotine attachment of FIG. 22;

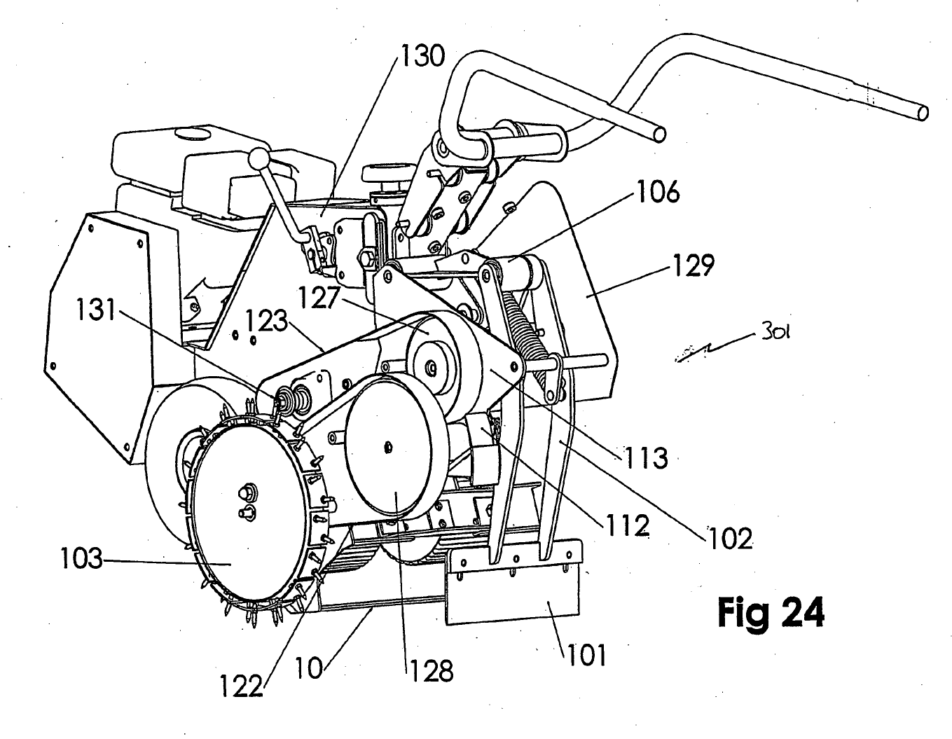

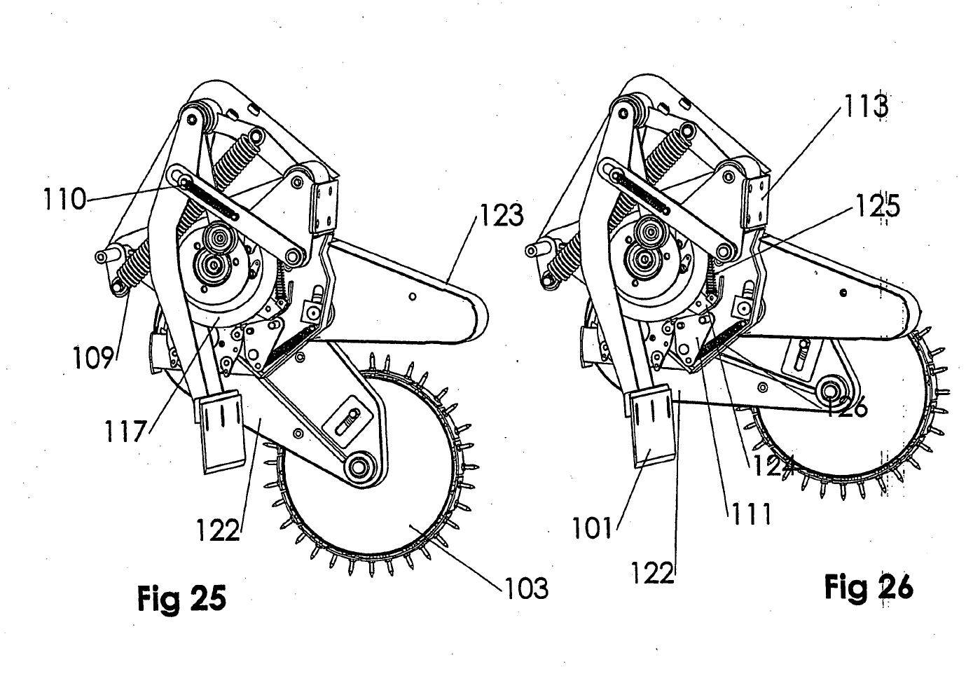

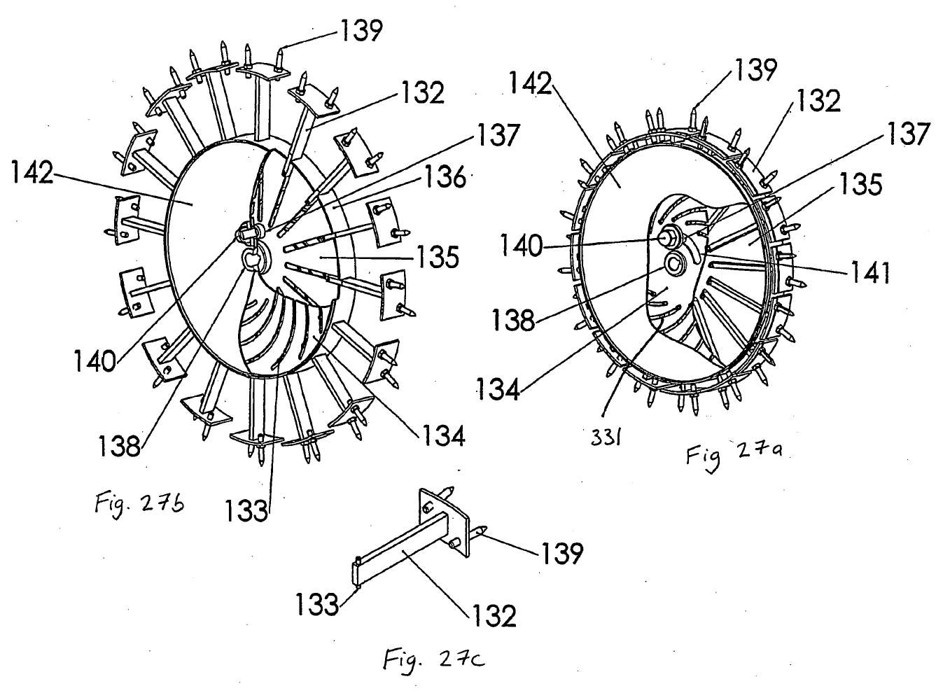

FIG. 24 is a second perspective view of the turf cutting apparatus of FIG. 22 with a guillotine attachment;

FIG. 25 is a second perspective detail view of the guillotine attachment of FIG. 23;

FIG. 26 is a third perspective detail view of the guillotine attachment of FIG. 23;

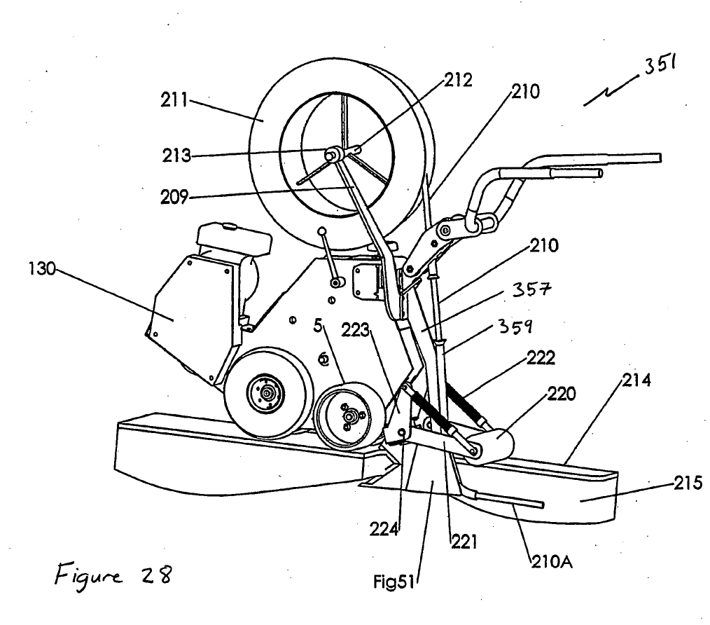

FIGS. 27a, 27b and 27c are three views of a ground measuring wheel, namely a perspective view 27a, a partial perspective view 27b and a detail view of a component of the wheel 27c;

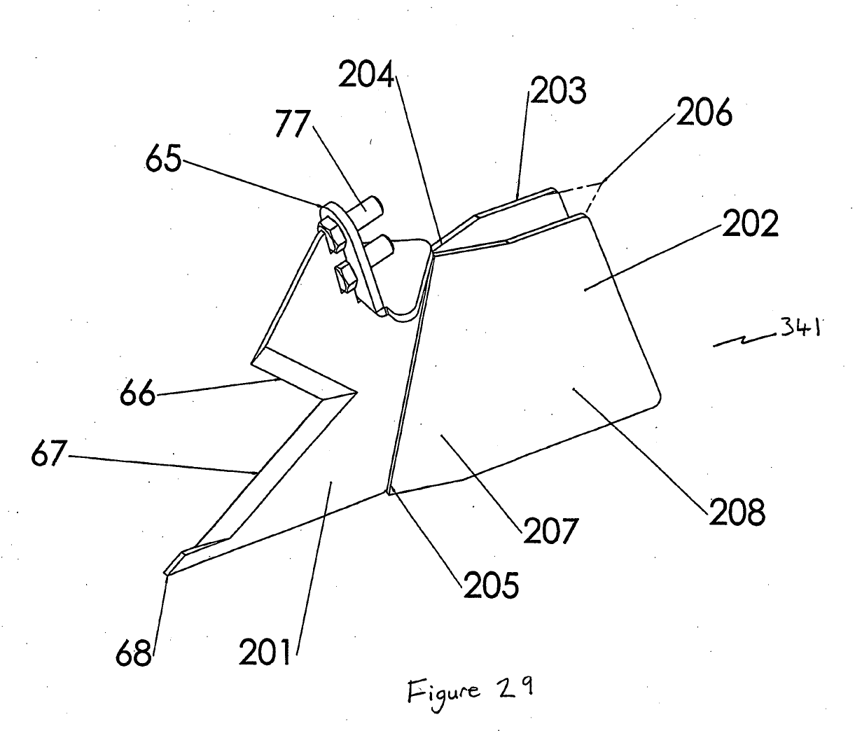

FIG. 28 is a perspective view of an irrigation/drainage apparatus;

FIG. 29 is a perspective view of a wedge blade for use with the irrigation/drainage apparatus;

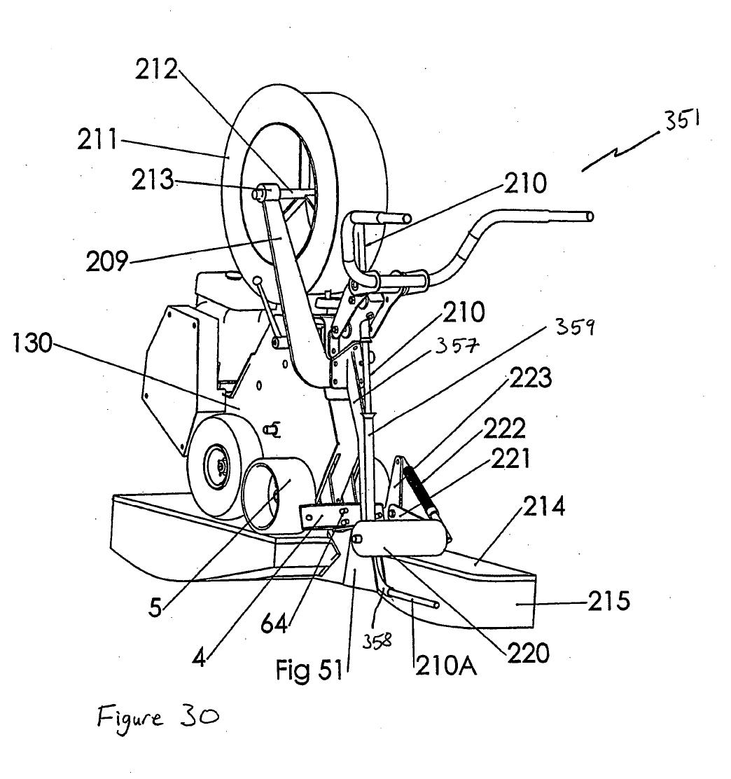

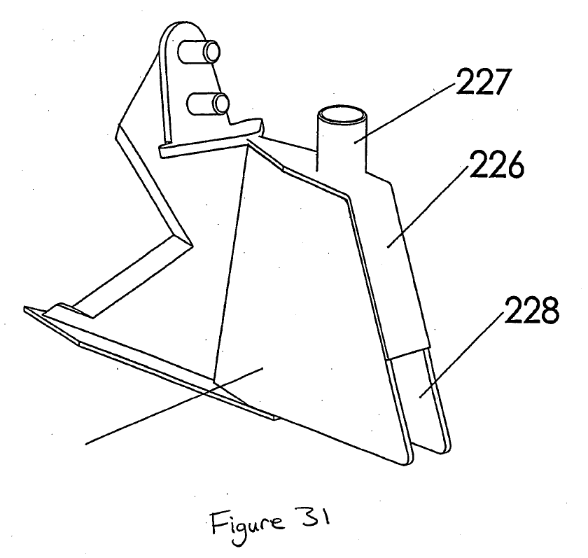

FIG. 30 is a second perspective view of the irrigation/drainage apparatus of FIG. 28;

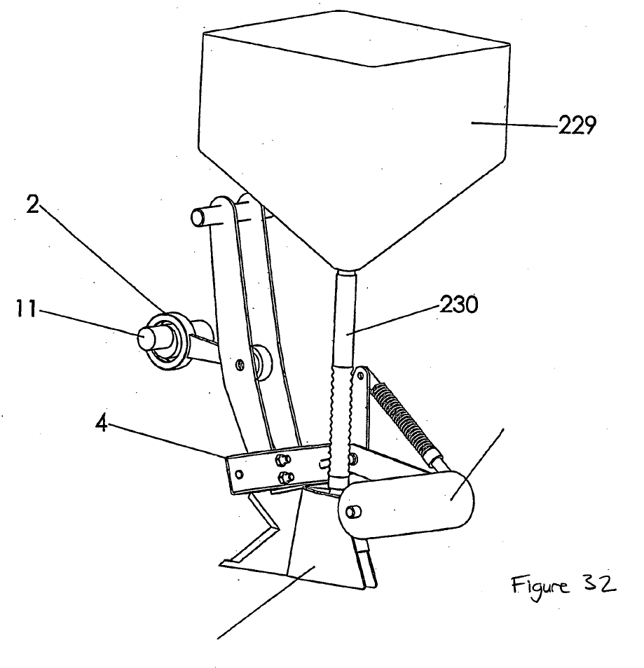

FIG. 31 is a perspective view of a second embodiment of wedge blade;

FIG. 32 is a perspective view of an attachment for inserting material;

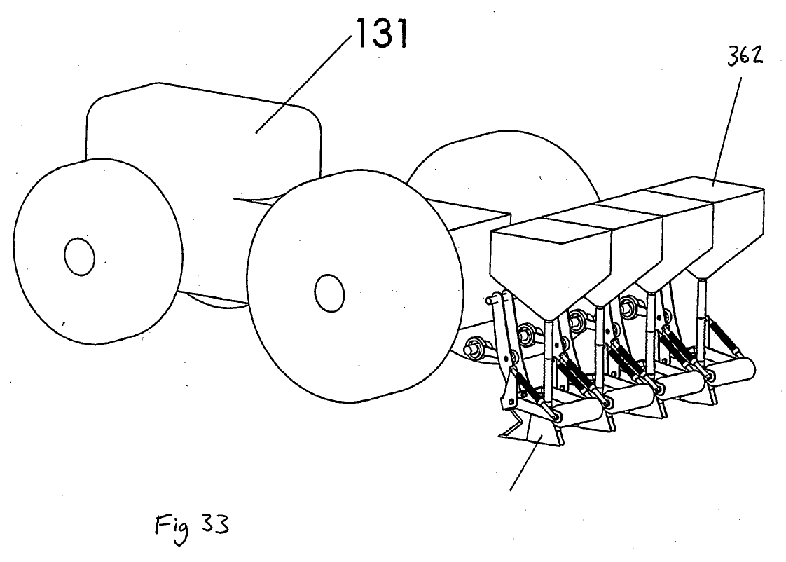

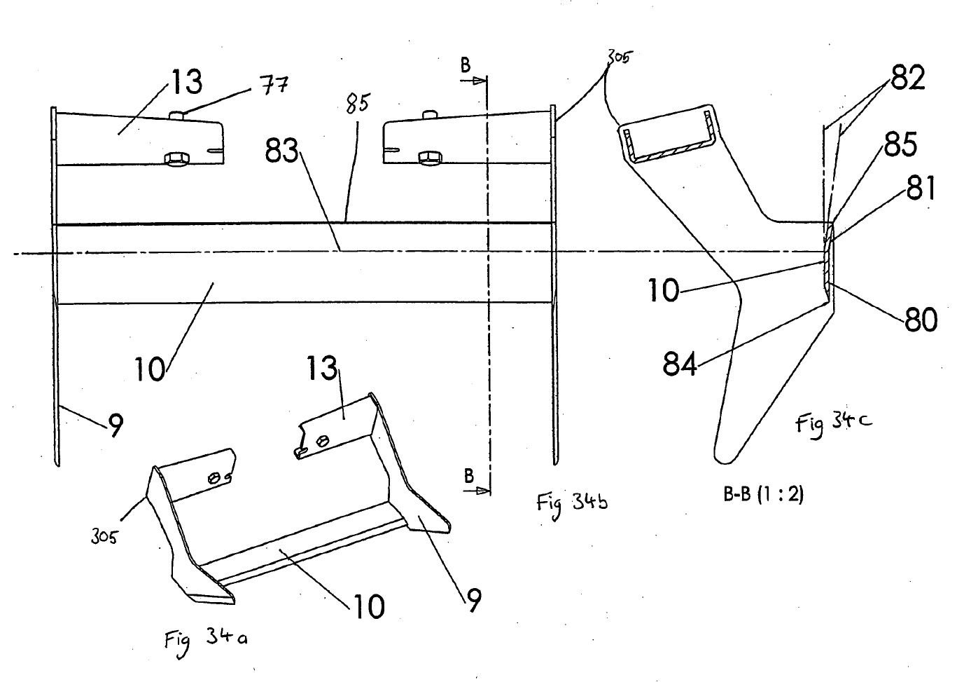

FIG. 33 is a perspective view of one embodiment of a tractor mounted arrangement; and

FIGS. 34a, 34b and 34c are three views of a turf cutting knife with a re-inforced turf undercutting blade namely a perspective view 34a, a top plan view 34b and a section view 34c.

Referring to the drawings and initially to FIG. 1, FIG. 2, FIG. 8, FIG. 9 and FIGS. 19 to 21, there is shown an apparatus for cutting turf indicated generally by the reference numeral 301. The turf cutting apparatus 301 has a chassis 1 with a ground engaging mechanism comprising a forward axle 8, an aft axle 14 and wheels 5 carried on the aft axle 14 and wheels 61 carried on the forward axle 8. An adjustable working arm 3 has a chassis-engaging end 302 which is movably mounted on the chassis 1 and a tool-engaging end 303 having a mechanism in the form of a crossbar 4 for receiving a turf cutting knife 305. The turf cutting apparatus 301 has a mechanism for oscillating the tool-engaging end 303 of the adjustable working arm 3. The oscillating mechanism comprises a drive arrangement (the details of the drive arrangements are described more fully below with reference to FIG. 2 and FIGS. 9 to 11) mounted on the chassis 1 and a connecting rod 2 mounted intermediate the drive arrangement and the adjustable working arm 3. The drive arrangements are all operated by a motive power source 12 which is mounted on the forward portion of the chassis 1. The connecting rod 2 is a single element connecting rod 2. The connecting rod 2 is mounted on the adjustable working arm 3 intermediate its two ends 302 and 303 via pivotal connection 46. The chassis-engaging end 302 of the adjustable working arm 3 is pivotally mounted on a housing 27 which is movably mounted on the chassis 1. The details of this housing 27 and its operation are set out below with reference to FIG. 7. The turf cutting apparatus 301 is pivotable about the forward axle 8 to allow the turf cutting knife 305 or any tool to be raised clear of the ground when out of use (see FIG. 18 illustrating this principle for a sub plough de-compactor apparatus 314). The chassis 1, the adjustable working arm 3 and the oscillating mechanism are contained within the boundary defined between the wheels 5, 61 of each axle 14, 8 respectively. The tool receiving end 303 of the adjustable working arm 3 has a crossbar 4 mounted thereon which has a longitudinal axis substantially parallel to the axis of rotation of the axles 8, 14. The longitudinal axis of the crossbar 4 is perpendicular to the plane of oscillation of the adjustable working arm 3.

Referring now to FIG. 15 and FIG. 34a, 34b and 34c, a turf cutting knife indicated by the reference numeral 305 is shown having a turf undercutting blade 10 orientated substantially horizontally in use which is mounted on the tool receiving end 303 of the adjustable working arm 3 and the turf undercutting blade 10 is located vertically below (indicated by a vertical centre line 6 through axle 14 in FIG. 2) an axis of rotation of the aft axle 14. The turf cutting knife 305 has turf undercutting blade 10 and a turf side-cutting blade 9 extending upward and rearward from each lateral edge of the turf undercutting blade 10. The side cutting blades 9 having mounting brackets 13, 13a on their free ends for mounting the turf cutting knife 305 onto a crossbar 4 mounted on the tool receiving end 303 of the adjustable working arm 3.

The turf cutting apparatus 301 maintains precision of cut by positioning the turf undercutting blade 10 under or close to the vertical centre line 6 of axle 14. This ensures that the turf strip thickness (see FIG. 2) is constant along the length of the strip 120. To maintain this accuracy across the width of the turf strip 120, the turf undercutting blade 10 must remain straight over the span of its width. The downward cutting angle required to keep the turf undercutting blade 10 in the ground puts pressure on the top plane of the turf undercutting blade 10. This pressure has the tendency to bow the turf undercutting blade 10 when in use thereby creating a thicker cut towards the centre of the said turf strip 120. This is particularly true with wider cutting blades.

Referring in particular to FIG. 19, the bowing of the turf undercutting blade 10 can be rectified by incorporating a stiffening angle 82 across the entire width of the turf undercutting blade 10. The bend centre line 83 is positioned towards the trailing edge 85 and creates a leading plane 80 which is the cutting portion of the turf undercutting blade 10. The trailing plane 81 is the stiffening portion and the bend angle 82 is minimal as is the trailing plane portion to achieve the required stiffness. In use, the leading plane 80 has a downward cutting angle in the direction of cut and the trailing plane is more or less horizontal to the direction of cut. The turf strip 120 flows over the turf undercutting blade 10 creating less downward pressure. The turf undercutting blade 10 is stiffened and the downward pressure reduced.

In FIG. 15, the mounting brackets 13, 13a of the turf cutting knife 305 extend from the side cutting blades 9 and the brackets 13, 13a have bolts 77 for insertion into apertures formed in the crossbar 4 and the bolts 77 have threaded ends for receiving nuts for releasably fastening the turf cutting knife 305 to the crossbar 4. Two different turf cutting knives 305 are shown in FIG. 15 provided with brackets 13, 13a of different lengths to accommodate blades 10 and/or wheels 5 of different widths (see FIG. 20 and FIG. 21). The side cutting blades 9 have a main plane substantially parallel to the direction of travel of the turf cutting apparatus 301 and are disposed laterally along the outside of the wheels 5. Advantageously, this allows an operator to visually align the last cut edge of turf with the side cutting blade 9 of the turf cutting knife 305 which is adjacent the last cut edge of turf.

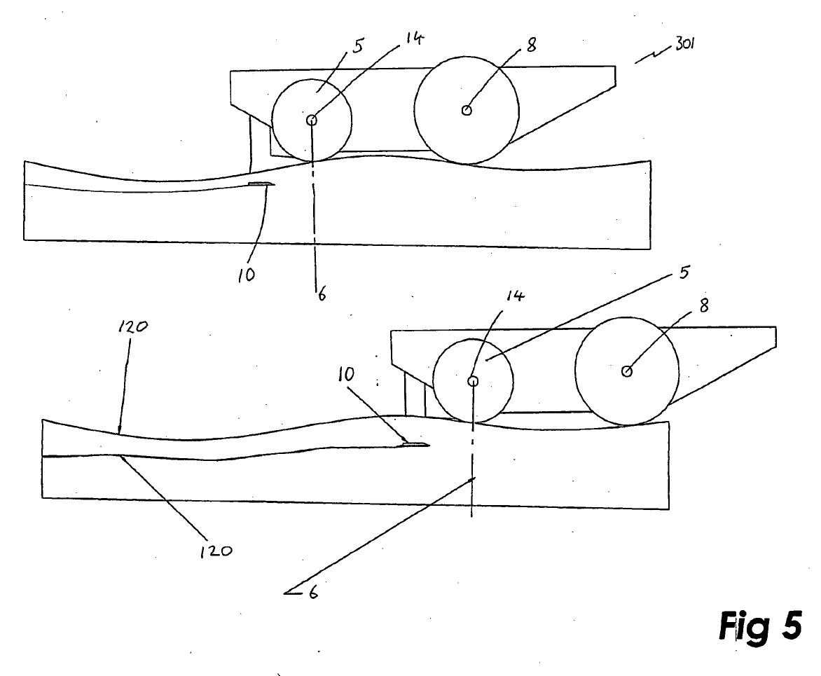

Referring to the drawings and now to FIG. 3, there is shown schematically the problem associated with turf undercutting blade 10 being located centrally between the axles 8, 14. The main problem with this configuration of turf cutting apparatus 301 is that the turf strip 120 has an uneven depth because the turf undercutting blade 10 is rising and falling relative to two reference points namely axles 8 and 14 as opposed to one reference point. FIG. 4 shows the turf cutter apparatus 301 of the present invention where the turf undercutting blade 10 is located vertically below the axle 14 which results in a turf strip 120 having a consistent depth. The depth of the turf strip 120 is consistent because the turf undercutting blade 10 is following a single point of reference, namely axle 14. FIG. 5 illustrates a third arrangement of turf cutting apparatus 301 in which the turf undercutting blade 10 lags behind the rear wheels 5. In this arrangement the turf strip 120 is also of uneven depth as a result of the positional variation of the turf undercutting blade 10 as a result of the relative vertical movement of the two axles 8 and 14.

Referring to FIGS. 12, 13, 14, 16 and 18 a sub plough de-compaction apparatus is indicated generally by the reference numeral 314. A single blade 70 is centrally mounted on the crossbar 4. FIG. 12 shows blade chisel point 68 located vertically below the axle 14 of wheels 5. FIG. 13 show the central mounting bracket 65 of the de-compactor blade 70 mounted to the crossbar 4. FIG. 14 graphically illustrates that blade chisel point 68 is located vertically below the axle 14 of wheels 5.

Referring now to FIGS. 16 and 17, the de-compacting blade 70 and mole drain blade 69 are fashioned in the same manner as the side cutter blades 9. A singular blade 70 is fixedly attached to centre mounting bracket 65 along its upper edge in use. The mounting bracket 65 bolts to the centre mounting holes 64, see FIG. 21 on the crossbar 4. The front or foremost edge of the single blade 70 extends forward and forms a v-shape. The said vee is the cutting edge of the blade 70, the upper v-portion 66 slicing through the grass roots in the same manner as the side blades 9. The lower v-portion 67 extends forward and downward ending in a blade chisel point 68. The said lower portion 67 cuts through the soil under the surface and its downward angle helps to pull the blade 70 into the ground for maximum depth in compacted soil. The lower edge 73 of the blade extends backward and slightly downward from the blade chisel point 68. To improve wear and tear, the blade 70 has the chisel tip 68 on a horizontal plane to the same width or wider than the blade thickness. Off-set plough plate section 72 of the blade 70 is offset from the main plane of the blade 70. This off-set plough plate section 72 is angled about bend axis 74 which runs from about halfway along the said lower edge 73 angling backward to join the said rearward edge 72 at a point just below the turf grass surface when in use. The off-set plough plate section 72 projects the rear lower portion of the blade 70 sideways and upwards and thereby acts as a plough. The plough would affect only the soil under the grass surface shifting it side ways and upwards on the blade thrusts forward. The rearward bottom corner would effect a chopping action on the rearward stroke. The shifting and chop action would be effective in relieving the problem of compaction, improve drainage and stimulate root growth.

Referring now to FIG. 17, in the case of the mole drain blade 69 the said point would have bullet 71 attached to create a circular drain under the turf surface.

The traditional method of tilting the machine forward in order to raise the cutter clear of the ground requires that the turf undercutting blade 10 follow a sufficient distance behind the rear wheel axle 14. The turf undercutting blade 10 cannot be lifted clear of the ground when it is positioned directly below blade wheel aft axle 14 so a second wheel axle or front axle 8 is required directly in front of the aft axle 14. The forward axle 8 is positioned in the centre of the chassis 1 for balance and for ease of handling. Both axles 8 and 14 can be driven. Details of the drives are set out below.

Referring to FIGS. 2, 10 and 11 details of the different types of drive mechanism 301 are set out. Initially, referring to FIG. 2 and by way of example the power is transmitted to the oscillating mechanism as follows. The engine motive power source 12 transfers drive through engine clutch 19 which has centrifugal engagement to lay shaft 20 via v-belt 21. Lay-shaft sprocket 22 transfers the drive via cam drive-chain 23 to cam-shaft sprocket 24. The forward axle 8 is used for transporting and turning the machine 301 between cuts and therefore if it is driven it incorporates a clutch mechanism to disengage the drive.

The clutch mechanism is capable of engaging at any point of rotation such as a disc or cone clutch. The operator activates the clutch mechanism by a lever 26 with a direct linkage such as toggle rod 25, see FIG. 9. Drive is transferred from cam shaft 11 to the said front axle either directly or via a compound sprocket or sprockets (43, 51, 44, 48) in order to achieve the correct gearing or ground speed. Alternatively a variable speed drive (FIG. 11) such as an expanding pulley or self contained hydrostatic unit or gearbox could be incorporated. This would give the operator a choice of cutting speeds plus rapid transport and reverse. The drive to the alternative drive unit would come directly from the power source or engine. This would enable the drive to be disconnected from the blade drive mechanism when in transport mode. The ground engaging blade wheels (5) on the aft axle are as important in the cutting operation as the blades themselves. If they are driven they remain permanently in drive (they do not need to free wheel) because they leave the ground with the blade when raised clear of the ground and out of work.

Turf cutter blades (see FIG. 15 and FIGS. 34a, b and c) have side blades 9 which act as knives to slice the turf to width. In the interests of leaving a clean edge on the cut turf it is essential that the forward cutting edge is angled relative to the turf surface to effect a slicing action rather than a torn ragged edge.

Given that a turf cutter should be capable of cutting a 30 cm (12 inch) width, a narrow chassis and drive mechanism is essential. Traditionally turf cutter blades have been driven by a crank shaft incorporating two connecting rods. In order to function within the said constraints, one aspect of the present invention has been designed with only one connecting rod. It is driven with a cam-shaft 11 rather than a crank and the cam-shaft 11 and drive mechanism is contained within the narrow chassis 1 and enclosed to protect it from soil and debris thrown from the cutter blade. The single connecting rod 2 imparts a forward and backward horizontal stroke to the cutter blade 10 via an adjustable working arm 3 comprising a double leg structure which is pivotally connected to the depth set housing 7 at its uppermost end. The double leg structure extends through two narrow slots 16, see FIG. 8 and FIG. 21 to the rear of the said narrow chassis 1 and attaches to a crossbar 4. The crossbar 4 has mounting points for various turf cutting knives 305, its rearward position makes it accessible by the operator no change knives 305. The uppermost pivotal connection 17 of the double leg structure has a mechanism to adjust the pivotal connection along a vertical axis 18 in order to adjust the depth or thickness of cut.

Referring now to FIG. 7, the housing 27 is a depth-set housing which is movable along a pair of mutually opposing slots 29 defined by the chassis 1 about a substantially vertical axis for adjusting the depth of a tool relative to the surface of the ground. The depth adjustment mechanism consists of depth-set housing 27, one end of which retains a pivot pin 17 extending from the chassis engaging end 302 of the adjustable working arm 3. The other end of the housing 27 consists of a hollow cross member 201 through which depth clamp bolt 28 passes. The depth clamp bolt 28 extends through the depth adjustment slots 29 which are cut through both sides of the chassis 1. The depth clamp bolt 28 also passes through a similar slot 329 which is cut through a free end of a depth clamp plate 30. The other end of the depth clamp plate 30 is rigidly bolted to the chassis 1 with spacer plate 31 sandwiched there between to maintain a gap between the depth clamp plate 30 and the chassis 1. The slot 329 of the depth clamp plate 30 is thereby free to clamp and release by flexing as the depth clamp bolt 28 is tightened and released by a threaded clamp lever 32. A depth adjustment spindle 34 extends through a hole in the upper face of the chassis 1 in a manner which allows the spindle 34 to rotate while being restricted in linear or vertical movement. Depth-set hand wheel 35 is attached to the upper end of the depth adjustment spindle 34. The lower portion of the spindle 34 is threaded and extends downward through a threaded hole in the central portion of the depth set housing 27. When the depth clamp lever 32 is released the depth set housing 27 can be raised and lowered along the path of the slots 29 by turning the said depth set hand-wheel 35. Depth pointer 33 is fixedly attached to the head of the depth clamp bolt 28. The said depth clamp bolt head is square or rectangular shaped to fit between guide rails 36 which form part of the depth clamp plate 30 and thereby prevent the bolt head from rotating. A depth scale 222 can be fixedly attached to or inscribed into the outer face of the depth clamp plate 30. The depth pointer 33 coinciding with the depth scale 222 accurately indicates the depth of cut or thickness of turf. After the desired depth is selected by turning the depth-set hand wheel 35, the depth-set housing 27 is locked in position by tightening the threaded clamp lever 32. The hollow cross member 201 of the depth set housing 27 is firmly clamped between the flexible depth clamp plate 30 and the rigid side of the chassis 1. The depth set housing 27 can thereby withstand the thrusting action of the cutter blades 9, 10 which are attached to the tool engaging end 303 of the adjustable working arm 3 without slipping or coming loose.

A second embodiment of turf cutting apparatus 130 is shown in FIG. 6 and has the front axle 8 carrying wheels 61. The apparatus 130 is pivotable about the axle 8 to allow any tool to be raised clear of the ground when out of use. Sectors of the market place may wish to have the advantages of the turf cutting apparatus 301 but not require the fine setting features or be able to justify the cost associated with the fine setting as defined with reference to FIG. 7. The landscaping industry falls into this category and a second embodiment is hereby described for a basic and simplified turf cutter 130 which maintains the basic principals previously illustrated but which has been customised for this sector of the Industry.

The precision blade depth adjustment mechanism illustrated in FIG. 7 and described above is replaced with a fixed pivot block attached by anchor bolts 98. The driven rear wheel axle 14 has been replaced by rear axle bracket 90 which is also the means of setting the depth of cut. To accommodate the said rear wheel axle the chassis 1 of the turf cutting apparatus 130 has been cut away at chassis cropped section 97. The blade cutting depth is adjusted by loosening clamp bolts 93 and raising or lowering the rear axle bracket 90. The depth is indicated by Depth Indicator 95 on a scale provided. The driven blade wheels 5 have been replaced with free wheeling blade rollers 94.

Referring especially to FIG. 15, a range of turf cutting knives 305 are available for the machine from 12 inch to 18 inch or any width between e.g. 12, 14, 16, and 18 inch. These are bolted to the extreme right and left mounting points on the blade mounting crossbar 4. The blade wheels 5 are also available in widths which correspond with the knives 305. These are interchangeable and although a 12 inch blade wheel 5 could be used with a wider blade, lateral precision of cut and stability would suffer. In the interests of maintaining lateral precision of depth (turf thickness) blade wheels 5 which correspond to the blade width must be used. The said blade mounting cross-member 4 is positioned a sufficient distance behind the blade wheels 5 to allow it to oscillate.

With reference to FIGS. 22 to 26, the guillotine main frame 113 bolts to the accessory attachment plate 78 on the turf cutting apparatus 301. The downward thrust of guillotine blade 101 is assisted by guillotine main spring 109. The guillotine blade 101 cuts the turf 120 to accurate lengths 119. A crankshaft 107 is driven by a chain or belt picking up the drive from a convenient location on the turf Cutting apparatus 301 such as auxiliary drive sprocket 131 mounted on the external end of cam shaft 11. The crank drive is engaged and disengaged by crank clutch 117 which is incorporated in the crankshaft 107. The crank clutch engagement is triggered by pawl 114 coming into contact with trigger bracket 111 rotating it about its axis allowing for the release of the clutch engagement lever 124 to engage the said crank clutch 117 by the force of clutch engagement spring 125. The pawl disc 108 can accept one or more pawls 114 on equal spaced holes provided about its circumference for the purpose of altering the frequency and thereby the length of guillotined turf strips. The pawl disc 108 is driven by a chain or belt from the ground measuring wheel 103 (shown spiked) which is extended forward on the foremost end of the measuring wheel casing 122. The measuring wheel casing 122 pivotally attaches on the same axis as trigger drive sprocket 128 and houses the drive chain or belt. Warning indicator plate 112 is attached via a rod to the axles of the trigger bracket 111. As the pawl 114 starts to move the trigger bracket 111 and the said warning indicator plate 112 begins to rise up from behind the warning indicator shield 112A which is attached to the main frame 113. This alerts the operator that the guillotine is about to be activated. It is desirable to have both ends of the turf lengths 119 cut with the guillotine 101. In the interest of avoiding waste by having to discard the first piece of each swath, it is necessary to activate the guillotine 101 at the commencement of the swath as soon as the turf undercutting blade 10 has reached its correct depth. To enable the operator to accomplish this, the pivoting measuring wheel casing 122 which is free floating to allow the said ground measuring wheel 103 to follow the turf contours, is fitted with an adjustable lower limit stop. This stop is set to allow the measuring wheel 103 to remain on the ground after the said turf undercutting blade 10 has cleared. The operator can allow the turf cutting apparatus 301 to continue forward until the warning indicator plate 112 rises to warn that the guillotine 101 is about to chop. The operator can now clear the ground measuring wheel 103 from the ground and the chop will activate shortly after re-entering the turf.

The following is a brief description of how the guillotine 101 functions. Blade legs 102 are pivotally connected to over arm 106 which pivotally connects at its other end to the guillotine attachment bracket 113. Connection link 104 is pivotally connected to the bracket 113 at a point below the over arm pivotal connection 116 and at its other end in a slot. The connection link 104 is mounted more or less parallel to the over arm 106 and maintains the blade legs 102 in a vertical attitude through-out the chop cycle or crank rotation. The slot allows the blade legs 102 to pivot backwards to enable the chop blade 101 to move rearwards to enable the turf cutting apparatus 301 to continue forward while the chop blade 101 is in contact with the turf 120. Bias spring 110 ensures that the blade legs 102 return to the forward end of the slot moving the chop blade 101 to its foremost position between cuts.

The guillotine blade 101 is interchangeable to coincide with the width of the turf undercutting blade 10. It is adjustably attached to blade legs 102 in order to penetrate the ground deep enough to sever the strip of cut turf 120. Slots are provided in the blade 101 to enable depth adjustment to facilitate different thicknesses of turf or to compensate for blade wear. The purpose of the guillotine is to chop the cut turf to pre-determined lengths for accurate re-laying or for sale by the Square Meter or Yard or simply just for convenient removal.

The length of the cut turf is adjusted by altering the number of trigger pawls 114 attached to the pawl disc 108. The outside diameter of the ground measuring wheel 103 is adjustable for fine adjustments.

This is illustrated in FIGS. 27a, 27b and 27c and described as follows.

Measure wheel spoke 132 is supported in the slots of wheel spoke guide disc 135 extending through the rectangular openings in the wheel spoke guide rim 136 to form semi-circle shoes into which drive spikes 139 can be inserted. Spoke pin 133 extends through the innermost end of the said measure wheel spoke 132 passing through the spiral slots 331 in the spiral adjuster disc 134 to either side. When the spiral adjuster disc 134 is rotated the measure wheel spokes 132 are propelled along the said spiral slots 331 extending and retracting and thereby adjusting the outside diameter of the ground measuring wheel 103. The wheel spoke guide disc 135 is centrally attached to measure wheel boss 138 and adjuster clamp boss 137. The spiral adjuster disc 134 is fitted at each side after the measure wheel spokes 132 have been inserted. The spoke pins 133 are correctly located in their corresponding spiral-slot 331 in the spiral adjuster disc 134 and clamped together by adjuster clamp bolt 140 along with the wheel cover discs 142. The adjuster clamp bolt 140 passes through the adjuster clamp boss 137 and the adjustment slot 141 allows the spiral adjuster disc 134 to rotate when the adjustment clamp bolt 140 is slackened to adjust the wheel 103.

Referring now to FIG. 29, a wedge blade indicated generally by the reference numeral 341 is designed to create a trench by displacing soil rather than removing it. The wedge blade 341 can be easily adapted to insert drainage material or piping for drainage or irrigation purposes.

With reference to FIG. 29, vertical leading edge blade 201 makes a vertical cut in the turf in the same manner as the mole drain blade 69 and de-compactor blades 70. The rearward edge of the vertical blade 201 is angled rearward and upwards and a separation angle 205 is formed where the leading edges of wedge plates 202/203 are attached to the rearward edge of the vertical blade 201. The wedge plates 202 and 203 are bent to create mutually opposing angled faces 207 and a pair of opposing parallel faces 208 providing one means for inserting material from above. The wedge plates 202 and 203 form a V which creates the wedge angle 204. The wedge angle 204 extends rearward to provide a separation gap 206. The angled face 207 of the wedge plates 202 and 203 forces the soil apart and the parallel faces 208 prevent the soil from collapsing into the cavity to facilitate material and/or pipe 212 insertion. The rearward and upward separation angle 205 utilises the angled faces 207 of the wedge plates to pull the vertical blade 201 into the soil as well as forcing the soil apart.

Referring to FIGS. 28 to 30, the wedge blade 341 is bolted to the centre mounting holes 64 on crossbar 4 of the drainage/irrigation apparatus indicated generally by the reference numeral 351. Insertion bracket 357 and reel bracket 209 bolt onto the accessory plate 78. Pipe 210 is fed from reel 211 into insertion tube 359 which is attached to insertion bracket 357. The insertion tube 359 extends down between wedge blade plates 202 and 203 into the separation gap 206 ending in a sweeping radius 358 at the bottom of the wedge plates 202 and 203. The pipe 210 is passed through the insertion tube 359 and staked to the ground at the commencement of the insertion run before the wedge blade 341 enters the soil. The displaced soil accumulates to either side of the wedge plates 202 and 203 raising the level of the grass surface to either side of the trench. This can be closed back into the trench cavity behind the wedge blade 341 if adequate pressure is applied to the grass surface 214. This is achieved by linking the oscillating motion of the crossbar 4 to a pressure plate or tamping roller 220. Roller linkage bracket 223 bolts to the outermost mounting points on the crossbar 4. Roller linkage 221 is pivotally connected to the roller linkage bracket 223 at pivot point 224. A bias means such as roller spring plunger 222 extends from the rearward end of the roller linkage 221 to the uppermost portion of the roller linkage bracket 223. The oscillating motion of the crossbar 4 imparts a vertical and horizontal motion to the tamping roller 220. Roller spring plunger 222 absorbs and releases the downward motion imparted to the roller 220 keeping the tamping roller 220 in contact with the ground to close in the soil cavity after the pipe or material insertion process. A damper can be incorporated in the spring plunger 222 and both damper and spring pressure adjusted for maximum compaction effect on the grass surface 214. The wedge blade 341 and roller 220 assists with the placing of pipe in the ground in one operation with little surface spoil or disruption closing the displaced soil back into the trench and over the inserted pipe or material.

Referring to the drawings and in particular to FIGS. 29, 31 and 32, the pipe reel 211 of FIGS. 28 and 30 can be replaced with material hopper 229 with flexible feed pipe 230 supplying material into the wedge blade separation gap 206 via material inlet manifold 227. The upper rear portion of separation gap 206 is enclosed with material baffle 226 which stops short of the bottom of the said wedge plates 202 and 203 creating material outlet port 228 by which the inserted material can exit into a trench. Wedge blades 341 are available with varying separation gaps 206 and material outlet ports 228 depending on the nature and quantity of material for insertion. The opening could be regulated by introducing a slot to the lower portion of the material baffle 226 by which to bolt an adjustable slide plate to alter the said material outlet port 228. Closing the upper portion of the separation gap 206 ensures that the trench cavity is filled from the bottom up and the blade oscillation assisting with releasing the insertion material and the supply pipe 230 helping to keep the material flowing from the material hopper 229.

The apparatus previously described have been illustrated on a self contained pedestrian operated machine. Referring now to FIG. 33, a separate and independent vehicle indicated by reference numeral 131 may be used to propel and power the oscillating mechanism and attachments. The vehicle 131 could operate a single oscillating unit or multiple units 362 as shown which could oscillate in unison or in a manner out of phase with each other. These units 362 could be linked together with a common drive and mounted in a frame such as illustrated in FIG. 33.

The mole blade 69 de-compaction blade 70 or wedge blade 341 can be mounted singularly or in multiples driven by a suitable mechanism as to impart the said back and forward oscillating motion in unison or in a manner out of phase. In a further arrangement the blades 69, 341 or 70 are multiply mounted in banks at suitable spacing. The banks could be in multiples and driven in the oscillating motion in a manor out of phase to reduce the traction requirements and vibration levels. When grouping the blades 69, 70 or 341 in multiples as described they could be positioned a suitable distance apart and behind each other as with the common multiple furrowed agricultural plough to enable the furrow or soil to move side ways as already described. The multiple groupings of the blades and oscillating drive mechanism could be incorporated into a frame for tractor mounting and driven with a power take off shaft. In another arrangement the blades could be rigidly fixed to a frame in the manner already described for group mounting and propelled by a suitable vehicle such as a four wheel drive tractor which would have sufficient traction as to propel it through the ground without the need for oscillations. These multiple groupings would be suitable for use in larger areas such as football pitches, golf fairways or on grass lands.

Variations and modification can be made without departing from the scope of the invention as defined in the appended claims.

1-32. (canceled)

33. An apparatus for cutting turf, for soil de-compacting and for soil drainage and irrigation, the apparatus comprising a chassis having ground engaging means, an adjustable working arm having a chassis-engaging end movably mounted on the chassis and a tool-engaging end having means for receiving a tool, means for oscillating the tool-engaging end of the adjustable working arm wherein the oscillating means comprises a drive means mounted on the chassis and a connecting means mounted intermediate the drive means and the adjustable working arm, wherein the ground engaging means comprises at least one axle having wheel means mounted thereon, whereby in use a leading portion of a tool on the tool receiving means is disposed substantially vertically below an axis of rotation of the axle.

34. An apparatus as claimed in claim 33, wherein the connecting means is a single connecting rod.

35. An apparatus as claimed in claim 33, wherein the drive means is a camshaft.

36. An apparatus as claimed in claim 33, wherein the chassis-engaging end of the adjustable working arm is pivotally mounted on a housing which is movably mounted on the chassis.

37. An apparatus as claimed in claim 33, wherein the ground engaging means comprises at least one axle carrying wheel means thereon, the apparatus being pivotable about the axle to allow the tool to be raised clear of the ground when out of use.

38. An apparatus as claimed in claim 33, wherein the ground engaging means comprises a pair of axles, an aft axle adjacent the tool engaging end of the adjustable working arm and a forward axle and at least one axle carrying wheel means thereon.

39. An apparatus as claimed in claim 33, wherein the tool is a turf cutting knife comprising a turf undercutting blade.

40. An apparatus as claimed in claim 39, wherein the turf undercutting blade is disposed substantially vertically below an axis of rotation of the axle.

41. An apparatus as claimed in claim 39, wherein the turf undercutting blade is reinforced.

42. An apparatus as claimed in claim 39, wherein a range of turf cutting knives are provided with brackets of different lengths to accommodate blades and/or wheels of different widths.

43. An apparatus as claimed in claim 33, wherein a guillotine is mounted on the aft portion of the chassis of the turf cutting apparatus and is operable between an out of use position where a cutting head of the guillotine is clear of the ground and an in use position where the cutting head slices vertically down into a strip of cut turf to produces strips of turf of a predetermined length.

44. An apparatus as claimed in claim 43, wherein the guillotine is operated between its two positions by guillotine drive means taken off the main turf cutting apparatus drive means.

45. An apparatus as claimed in claim 43, wherein the guillotine has a measuring means in operable engagement with a clutch means such that when a predetermined distance has been measured by the measuring means, the clutch means couples the guillotine cutting head to the guillotine drive means to operate the guillotine between the out of use position and the in use position and back to the out of use position effecting a chopping action by the guillotine cutting head.

46. An apparatus as claimed in claim 45, wherein the measuring means is a wheel having wheel diameter adjustment means.

47. An apparatus as claimed in claim 33, wherein a trench generating means is mounted on the tool receiving means of the adjustable working arm wherein the trench generating means comprises a wedge blade having a leading edge blade and a trailing edge having means for receiving material.

48. An apparatus as claimed in claim 1, wherein pipe dispensing means are mounted on the chassis of the apparatus.

49. An apparatus as claimed in claim 47, wherein the pipe dispensing means and the trench generating means are mounted on the apparatus for dispensing pipe into the material receiving means of the trench generating means for drainage and/or irrigation.

50. An apparatus as claimed in claim 49, wherein guide means is mounted on the chassis of the apparatus for guiding the pipe from the pipe dispensing means into the trench via the material receiving means.

51. An apparatus as claimed in claim 47, wherein a material hopper is mounted on the chassis and a material delivery means is connected intermediate the hopper and the material receiving means of the trench generating means.

52. An apparatus for soil drainage and irrigation, the apparatus comprising a chassis have ground engaging means, an adjustable working arm having a chassis-engaging end movably mounted on the chassis and a tool-engaging end having means for receiving a tool, means for oscillating the tool-engaging end of the adjustable working arm wherein the oscillating means comprises a drive means mounted on the chassis and a connecting means mounted intermediate the drive means and the adjustable working arm wherein a trench generating means is mounted on the tool receiving means of the adjustable working arm wherein the trench generating means comprises a wedge blade having a leading edge blade and a trailing edge having means for receiving material.
